(19) United States
(12) Patent Application Publication
(10) Pub. No.: US 2025/0002064 A1
(43) Pub. Date: Jan. 2, 2025

(54) FOLDABLE TROLLEY

(71) Applicant: Jibing Jiang, Pinghu (CN)

(72) Inventor: Jibing Jiang, Pinghu (CN)

(21) Appl. No.: 18/882,043

(22) Filed: Sep. 11, 2024

(51) Int. Cl. B62B 3/02

(52) U.S. Cl. CPC B62B 3/02; B62B 2205/20

(57) ABSTRACT

The present disclosure discloses a foldable trolley. The foldable trolley includes a longitudinal fixed frame, transverse connecting assemblies with symmetrically arranged front and back parts, and a push handle assembly fixedly arranged on the longitudinal fixed frame. The longitudinal fixed frame includes a plurality of vertical rods; a wheel is arranged below each vertical rod. In the present disclosure, a connecting way between triangular connecting components and a folding lock is adjusted by the folding lock, so that the transverse connecting assemblies are suitable for being opened or closed, which further enables the foldable trolley to be in the unfolded or folded state. The folding lock in the above structure has a simple structure and occupies a small space, so that the foldable trolley is easily and conveniently folded.

### TECHNICAL FIELD

The present disclosure relates to the technical field of trolleys, and in particular, to a foldable trolley.

### BACKGROUND

Trolleys are commonly used transportation tools in daily life and work. They bring great convenience to people. However, the existing conventional trolleys have the problem of occupying a large space and are not easy for storage and carrying. Therefore, various foldable trolleys have been designed in the existing solution, but most of them either have too many rod pieces and are folded unsmoothly, or have simple folding structures that still occupy a large space after being folded. The foldable trolleys are inconvenient to carry.

To ensure that a folded trolley can maintain its folded state, a lock is usually used to fix the folded state of the trolley. However, the lock in the prior art is usually cumbersome, so there is an urgent need for a simply structured self-locking mechanism to maintain the folded state of the trolley.

### SUMMARY

To facilitate the folding of a foldable trolley and make a self-locking structure for fixing a folded state of the trolley simple and occupy a small space, the present disclosure provides a foldable trolley.

The present disclosure is implemented using the following technical solution: A foldable trolley is provided, including: a longitudinal fixed frame, transverse connecting assemblies with symmetrically arranged front and back parts, and a push handle assembly fixedly arranged on the longitudinal fixed frame. The longitudinal fixed frame includes a plurality of vertical rods; a wheel is arranged below each vertical rod; the transverse connecting assemblies are hinged between the vertical rods that are adjacent to each other in a transverse direction and are suitable for being opened or closed to enable the foldable trolley to be in an unfolded or folded state; the transverse connecting assemblies include a first connecting assembly and a second connecting assembly; the first connecting assembly includes two triangular connecting components that are symmetrically arranged on the left and right; the two triangular connecting components are connected by a folding lock; the second connecting assembly includes two dual-triangular connecting components which are symmetrically arranged on the left and right; and the two dual-triangular connecting components are hinged by a connector.

In a further improvement of the above solution, each triangular connecting component includes a first connecting rod and a second connecting rod; the first connecting rod and the second connecting rod have close ends and far ends; the close end of the first connecting rod is hinged to the vertical rod; the far end of the first connecting rod is connected to the folding lock; the close end of the second connecting rod is fixedly connected to the vertical rod; and the far end of the second connecting rod is hinged to the first connecting rod.

In a further improvement of the above solution, the second connecting rod is a telescopic connecting rod.

In a further improvement of the above solution, each dual-triangular connecting component includes a third connecting rod, a fourth connecting rod, and a fifth connecting rod; the third connecting rod, the fourth connecting rod, and the fifth connecting rod have close ends and far ends; the close ends of the third connecting rod and the fifth connecting rod are hinged to the vertical rod; the far ends of the third connecting rod and the fifth connecting rod are connected to the connector; the close end of the fourth connecting rod is hinged to the third connecting rod; and the far end of the fourth connecting rod is hinged to the fifth connecting rod.

In a further improvement of the above solution, the third connecting rod and the fourth connecting rod are telescopic connecting rods.

In a further improvement of the above solution, several supporting connecting rods are fixedly arranged between the transverse connecting assemblies with symmetrically arranged front parts and rear parts.

In a further improvement of the above solution, a folding button is arranged on the folding lock; when the folding button is triggered, the first connecting rods of the triangular connecting components are all hinged to locking holes of the folding lock; and when the folding button is not triggered, the first connecting rods of the triangular connecting components are fixedly connected to the folding lock.

Compared with an existing trolley, the foldable trolley of the present disclosure has the following beneficial effects:

The foldable trolley in the present disclosure includes: a longitudinal fixed frame, transverse connecting assemblies with symmetrically arranged front and back parts, and a push handle assembly fixedly arranged on the longitudinal fixed frame. The longitudinal fixed frame includes a plurality of vertical rods; a wheel is arranged below each vertical rod; the transverse connecting assemblies are hinged between the vertical rods that are adjacent to each other in a transverse direction and are suitable for being opened or closed to enable the foldable trolley to be in an unfolded or folded state; the transverse connecting assemblies include a first connecting assembly and a second connecting assembly; the first connecting assembly includes two triangular connecting components that are symmetrically arranged on the left and right; the two triangular connecting components are connected by a folding lock; the second connecting assembly includes two dual-triangular connecting components which are symmetrically arranged on the left and right; and the two dual-triangular connecting components are hinged by a connector. In the present disclosure, a connecting way between the triangular connecting components and the folding lock is adjusted by the folding lock, so that the transverse connecting assemblies are suitable for being opened or closed, which further enables the foldable trolley to be in the unfolded or folded state. The folding lock in the above structure has a simple structure and occupies a small space, so that the foldable trolley is easily and conveniently folded.

### BRIEF DESCRIPTION OF THE DRAWINGS

FIG. 1 is a three-dimensional unfolded structural diagram of a foldable trolley according to an embodiment of the present disclosure.

FIG. 2 is a front view of a foldable trolley according to an embodiment of the present disclosure.

FIG. 3 is a structural diagram of a bottom of a foldable trolley according to an embodiment of the present disclosure.

FIG. 4 is a structural diagram of a folded state of a foldable trolley according to an embodiment of the present disclosure.

### DETAILED DESCRIPTION OF THE EMBODIMENTS

To make the objectives, technical solutions, and advantages of the present disclosure clearer, the following is a further detailed explanation of the present disclosure in conjunction with the accompanying drawings and embodiments. It should be understood that the specific embodiments described here are only intended to explain the present invention and are not intended to limit the present invention.

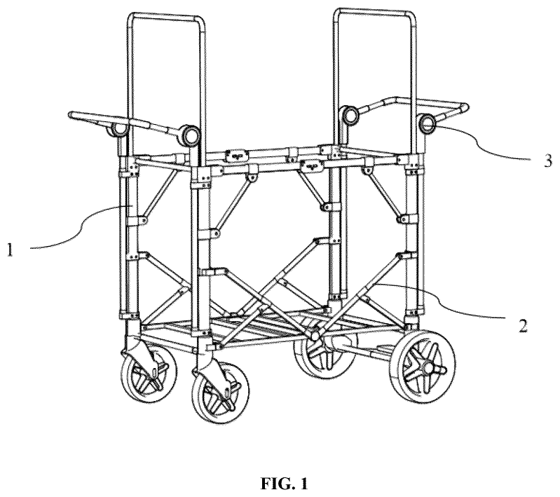

Referring to FIG. 1 to FIG. 3, an embodiment of the present disclosure provides a specific structure of a foldable trolley. The foldable trolley with the structure includes a longitudinal fixed frame 1, transverse connecting assemblies 2 with symmetrically arranged front and back parts, and a push handle assembly 3 fixedly arranged on the longitudinal fixed frame.

The longitudinal fixed frame 1 includes a plurality of vertical rods 11. A wheel 12 is arranged below each vertical rod 11.

Specifically, the longitudinal fixed frame 1 includes four vertical rods 11 distributed at a periphery of the foldable trolley. A wheel 12 is arranged below each vertical rod 11.

The transverse connecting assemblies 2 are hinged between the vertical rods 11 that are adjacent to each other in a transverse direction and are suitable for being opened or closed to enable the foldable trolley to be in an unfolded state or a folded state. The two groups of transverse connecting assemblies 2 are symmetrically arranged between the front and rear adjacent vertical rods 11.

The transverse connecting assemblies 2 include a first connecting assembly 21 and a second connecting assembly 22. The first connecting assembly 21 includes two triangular connecting components 23 that are symmetrically arranged on the left and right. The two triangular connecting components 23 are connected by a folding lock 24. The second connecting assembly 22 includes two dual-triangular connecting components 25 which are symmetrically arranged on the left and right. The two dual-triangular connecting components 25 are hinged by a connector 26. The folding lock 24 is configured to adjust a connecting way between the triangular connecting components 23 and the folding lock 24. The connecting way between the triangular connecting components 23 and the folding lock 24 includes fixed connection and hinge connection.

In this embodiment of the present disclosure, the transverse connecting assemblies are arranged on the longitudinal fixed frame. When the foldable trolley is in an unfolded state, the transverse connecting assemblies fixedly support the foldable trolley through the triangular connecting components and the dual-triangular connecting components. Furthermore, a connecting way between the triangular connecting components and the folding lock is adjusted by the folding lock, so that the transverse connecting assemblies are suitable for being opened or closed, which further enables the foldable trolley to be in the unfolded or folded state. The folding lock in the above structure has a simple structure and occupies a small space, so that the foldable trolley is easily and conveniently folded.

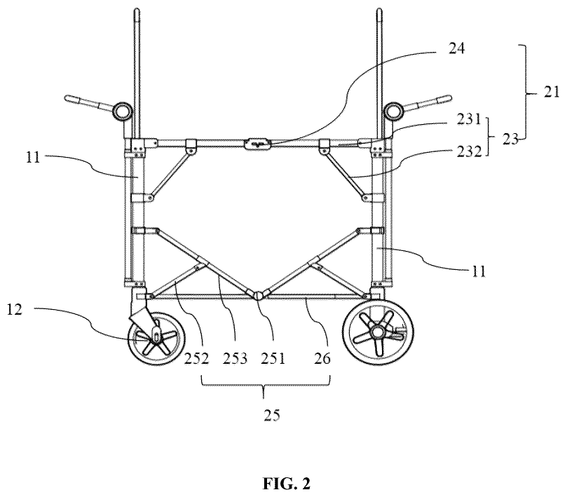

In an embodiment of the present disclosure, referring to FIG. 2, each triangular connecting component 23 includes a first connecting rod 231 and a second connecting rod 232. The first connecting rod 231 and the second connecting rod 232 have close ends and far ends.

The close end of the first connecting rod 231 is hinged to the adjacent vertical rod 11. The far end of the first connecting rod 231 is connected to the folding lock 24. The close end of the second connecting rod 232 is fixedly connected to the adjacent vertical rod 11.

It should be noted that the second connecting rod 232 is a telescopic connecting rod. When the triangular connecting component 23 is folded downwards, the second connecting rod 232 is in a retracted state.

In this embodiment of the present disclosure, when the foldable trolley is in the unfolded state, the triangular connecting component 23 can make the foldable trolley more stable in the unfolded state.

In an embodiment of the present disclosure, referring to FIG. 2, each dual-triangular connecting component 25 includes a third connecting rod 251, a fourth connecting rod 252, and a fifth connecting rod 253. The third connecting rod 251, the fourth connecting rod 252, and the fifth connecting rod 253 have close ends and far ends.

The close ends of the third connecting rod 251 and the fifth connecting rod 253 are hinged to the vertical rod 11. The far ends of the third connecting rod 251 and the fifth connecting rod 253 are hinged to the connector 26. The close end of the fourth connecting rod 252 is hinged to the third connecting rod 251, and the far end of the fourth connecting rod 252 is hinged to the fifth connecting rod 253. When the foldable trolley is in the unfolded state, the third connecting rod 251, the fourth connecting rod 252, and the fifth connecting rod 253 form two triangles.

It should be noted that the third connecting rod 251 and the fourth connecting rod 252 are telescopic connecting rods. When the dual-triangular connecting component 25 is folded upwards, the third connecting rod 251 and the fourth connecting rod 252 are in a retracted state.

In this embodiment of the present disclosure, when the foldable trolley is in the unfolded state, the dual-triangular connecting component 25 can also make the foldable trolley more stable in the unfolded state.

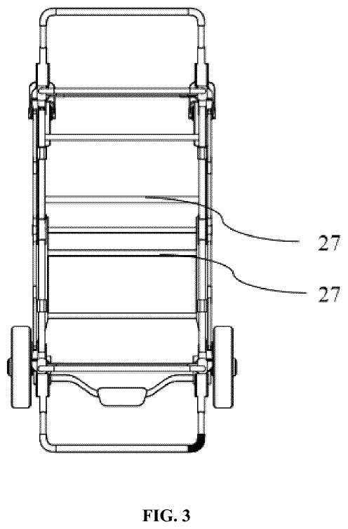

In an embodiment of the present disclosure, referring to FIG. 3, several supporting connecting rods are fixedly arranged between the transverse connecting assemblies 2 with symmetrically arranged front parts and rear parts.

In this embodiment of the present disclosure, the supporting connecting rods are configured to make the foldable trolley more stable in the unfolded state.

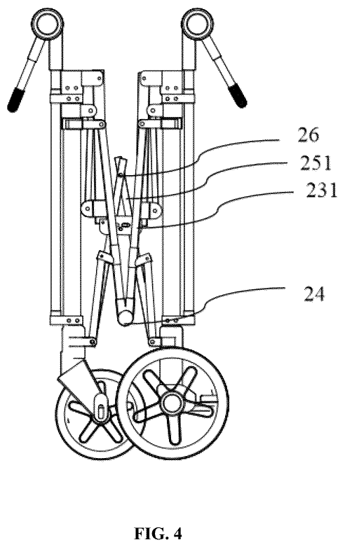

In ab embodiment of this present disclosure, referring to FIG. 4, a folding button is arranged on the folding lock 24; when the folding button is triggered, the first connecting rods 231 of the triangular connecting components 23 are all hinged to locking holes of the folding lock 24; and when the folding button is not triggered, the first connecting rods 231 of the triangular connecting components 23 are fixedly connected to the folding lock 24.

Specifically, when the folding button on the folding lock 24 is triggered, the first connecting rods 231 of the triangular connecting components 23 are hinged to the locking holes of the folding lock 24. When the folding lock 24 is pressed down, the first connecting rods 231 of the symmetrically distributed triangular connecting components 23 are folded down and drive the second connecting rods 232 to be retracted and folded synchronously, so that the two symmetrically distributed triangular connecting components 23 are in a folded state. When the triangular connecting components 23 are in the folded state, the symmetrically distributed fifth connecting rods 253 in the dual-triangular connecting components 25 are folded upwards around the connector 26, and the third connecting rods 251 and the fourth connecting rods 252 extend, so that the dual-triangular connecting components 25 are also in a folded state. When the folding button on the folding lock 24 is not triggered, the first connecting rods 231 of the triangular connecting components 23 are fixedly connected to the folding lock 24. When the folding lock 24 is pressed down, the first connecting rods 231 of the symmetrically distributed triangular connecting components 23 cannot be folded, thereby keeping the foldable trolley in the unfolded state.

In this embodiment of the present disclosure, when the folding lock 24 is pressed down, the first connecting rods 231 of the symmetrically distributed triangular connecting components 23 drive the second connecting rods 232 to be folded synchronously. The folding lock in the above structure has a simple structure and occupies a small space, so that the foldable trolley is easily and conveniently folded.

The above describes the preferred embodiments of the present disclosure and is not intended to limit the present disclosure. Any modification, equivalent replacement, and improvement made within the spirit and scope of the present disclosure shall fall within the protection scope of the present disclosure.

What is claimed is:

1. A foldable trolley, wherein the foldable trolley comprises a longitudinal fixed frame, transverse connecting assemblies with symmetrically arranged front and back parts, and a push handle assembly fixedly arranged on the longitudinal fixed frame;
the longitudinal fixed frame comprises a plurality of vertical rods; a wheel is arranged below each vertical rod;
the transverse connecting assemblies comprise a first connecting assembly and a second connecting assembly; the first connecting assembly comprises two triangular connecting components that are symmetrically arranged on the left and right; the two triangular connecting components are connected by a folding lock; the second connecting assembly comprises two dual-triangular connecting components which are symmetrically arranged on the left and right; the two dual-triangular connecting components are hinged by a connector; the folding lock is configured to adjust a connecting way between the triangular connecting components and the folding lock; and
the transverse connecting assemblies are hinged between the vertical rods that are adjacent to each other in a transverse direction and are suitable for being opened or closed to enable the foldable trolley to be in an unfolded state or a folded state.

2. The foldable trolley according to claim 1, wherein each triangular connecting component comprises a first connecting rod and a second connecting rod; the first connecting rod and the second connecting rod have close ends and far ends; the close end of the first connecting rod is hinged to the vertical rod; the far end of the first connecting rod is connected to the folding lock; the close end of the second connecting rod is fixedly connected to the vertical rod; and the far end of the second connecting rod is hinged to the first connecting rod.

3. The foldable trolley according to claim 2, wherein the second connecting rod is a telescopic connecting rod.

4. The foldable trolley according to claim 1, wherein each dual-triangular connecting component comprises a third connecting rod, a fourth connecting rod, and a fifth connecting rod; the third connecting rod, the fourth connecting rod, and the fifth connecting rod have close ends and far ends; the close ends of the third connecting rod and the fifth connecting rod are hinged to the vertical rod; the far ends of the third connecting rod and the fifth connecting rod are connected to the connector; the close end of the fourth connecting rod is hinged to the third connecting rod; and the far end of the fourth connecting rod is hinged to the fifth connecting rod.

5. The foldable trolley according to claim 4, wherein the third connecting rod and the fourth connecting rod are telescopic connecting rods.

6. The foldable trolley according to claim 1, wherein several supporting connecting rods are fixedly arranged between the transverse connecting assemblies with symmetrically arranged front parts and rear parts.

7. The foldable trolley according to claim 1, wherein a folding button is arranged on the folding lock; when the folding button is triggered, the first connecting rods of the triangular connecting components are all hinged to locking holes of the folding lock; and when the folding button is not triggered, the first connecting rods of the triangular connecting components are fixedly connected to the folding lock.
